(19) United States
(12) Patent Application Publication
(10) Pub. No.: US 2004/0139307 A1
(43) Pub. Date: Jul. 15, 2004

(54) Method and apparatus for initializing a semiconductor circuit from an external interface

(76) Inventor: Philip C. Barnett, Clanfield (GB)

Correspondence Address: ATMI, INC., 7 COMMERCE DRIVE, DANBURY, CT, 06810, US

(21) Appl. No.: 10/339,223

(22) Filed: Jan. 9, 2003

(51) Int. Cl. G06F 15/177

(52) U.S. Cl. 713/1

(57) ABSTRACT

A method and apparatus are disclosed for initializing an unused semiconductor circuit from an external interface of the semiconductor circuit, such as a serial interface, parallel interface or a Universal Serial Bus (USB). A semiconductor circuit includes an unused state detection circuit that detects when the semiconductor circuit has not previously been booted up. When the semiconductor circuit is first booted up, the unused state detection circuit will automatically activate a boot up procedure. The processor on the semiconductor circuit can obtain the appropriate program code for the boot up process from the external interface. The external interface can be connected to a testing station or another external computing device that provides an instruction stream for execution by the processor to initialize the semiconductor circuit load the non-volatile memory with the appropriate application software. The processor continues to obtain instructions from the external interface until the initialization process is complete. Once the initialization process is complete, the unused state of the semiconductor circuit is permanently cleared.

### CROSS REFERENCE TO RELATED APPLICATION

The present application is related to U.S. patent application Ser. No. ______, entitled “Method and Apparatus for Detecting an Unused State in a Semiconductor Circuit,” (Attorney Docket Number ATM-626), filed contemporaneously herewith, assigned to the assignee of the present invention and incorporated by reference herein.

### FIELD OF THE INVENTION

The present invention relates generally to a method and apparatus for initializing a semiconductor circuit, such as a secure integrated circuit, and more particularly, to a method and apparatus for initializing an unused semiconductor circuit from an external interface, such as a serial port.

### BACKGROUND OF THE INVENTION

Semiconductor circuits, especially of the System on a Chip type, typically contain a microprocessor and non-volatile memory to perform required functions. When a semiconductor circuit is first powered up, the microprocessor requires a source of instructions to be able to function. Typically, semiconductor circuits include a read only memory (ROM) array, often referred to as a “boot ROM,” that has been masked at the time of manufacture to include the appropriate program code that allows the microprocessor to boot up and initialize the semiconductor circuit when power is first applied. A boot ROM, however, increases the required surface area of the semiconductor circuit, as well as the complexity of the microprocessor initialization processes. If the ROM is created as part of the fabrication process, errors that cause changes to this program code are very expensive and time consuming. In addition, a boot ROM impairs the security of a semiconductor circuit, since each cell in the boot ROM can be examined, e.g., using a microscope, to identify the program code that has been loaded onto the boot ROM. The security impairment is of particular concern when the semiconductor circuits are used for secure applications, such as banking or the recording of personal or proprietary information.

Thus, a need exists for an improved method and apparatus for initializing an unused semiconductor circuit.

### SUMMARY OF THE INVENTION

Generally, a method and apparatus are disclosed for initializing and/or testing an unused semiconductor circuit from an external interface of the semiconductor circuit, such as a serial interface, parallel interface or a Universal Serial Bus (USB). Upon a first use of a semiconductor circuit in accordance with the present invention, the processor on the semiconductor circuit processes instructions for initializing the semiconductor circuit that are received from the external interface. For example, when a semiconductor circuit is first powered up after fabrication, a testing station can provide an instruction stream to the semiconductor circuit using the external interface.

A semiconductor circuit according to the present invention includes an unused state detection circuit that detects when the semiconductor circuit has not completed testing and/or initialization. According to one aspect of the invention, when the semiconductor circuit is first powered up, the unused state detection circuit will automatically activate a boot up procedure. The processor on the semiconductor circuit can obtain the appropriate program code for the boot up process from the external interface. In one implementation, the external interface can be assigned an address in the code space of the processor, and the processor can be instructed to fetch instructions from the address assigned to the external interface. Alternatively, the processor can be made to fetch instructions from the external interface regardless of an address assignment.

The external interface can be connected to a testing station or another external computing device that provides an instruction stream for execution by the processor. The external computing device provides one or more commands to the semiconductor circuit through the external interface that indicates specific instruction(s) that should be implemented by the processor. The processor executes the instruction stream being provided by the external device as if it was reading from the on board memory. There is complete flexibility on the functioning of the device, without any reliance on internally stored code. In this manner, the semiconductor circuit is initialized and the non-volatile memory is loaded with the appropriate application software. The processor can continue to obtain instructions from the external interface until the initialization process is complete. In the unused mode, the external interface acts as another memory asset to the processor which occupies a specific memory space. Execution could be passed to other internal memory assets and returned to the external asset. In this manner, the entire semiconductor circuit can be tested and initialized. Once the initialization process, and any other desired operations, such as testing, are complete, the unused state of the semiconductor circuit is permanently cleared

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a conventional semiconductor circuit;

FIG. 2 is a schematic block diagram of a semiconductor circuit incorporating features of the present invention; and

FIG. 3 is a flow chart describing an exemplary implementation of a first use initialization process implemented by the testing station of FIG. 2.

### DETAILED DESCRIPTION

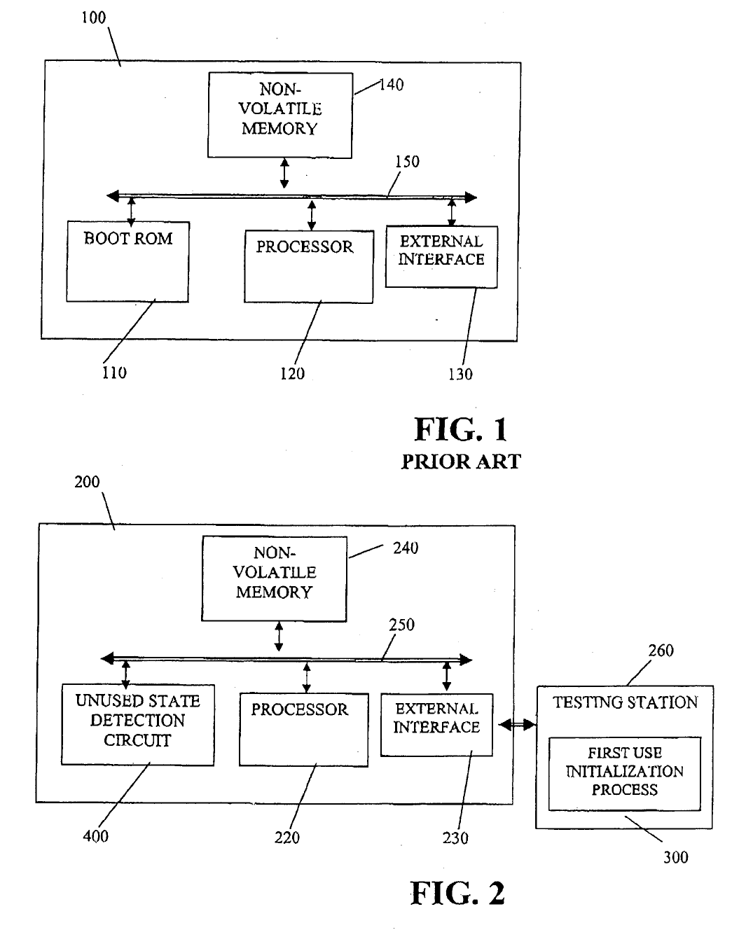

FIG. 1 is a schematic block diagram of a conventional semiconductor circuit 100. As shown in FIG. 1, the conventional semiconductor circuit 100 includes a Boot ROM 110, a processor 120, an external interface 130 and a non-volatile memory 140, each communicating over a bus 150. As previously indicated, when the conventional semiconductor circuit 100 is first powered up, the processor 120 accesses the Boot ROM 110 to obtain the appropriate program code for the boot up process.

FIG. 2 is a schematic block diagram of a semiconductor circuit 200 incorporating features of the present invention. As shown in FIG. 2, the semiconductor circuit 200 includes an unused state detection circuit 400, a processor 220, an external interface 230 and a non-volatile memory 240, each communicating over a bus 250. The processor 220, interface 230 and a non-volatile memory 240 operate in a conventional manner. The external interface 230 may be embodied in many forms, but typically would be a recognized standard, for example, as a serial interface, parallel interface or a Universal Serial Bus (USB). According to one aspect of the invention, when the semiconductor circuit 200 is first powered up, the unused state detection circuit 400 will detect that the semiconductor circuit 200 has not previously been used, e.g, tested or initialized, and had its unused state cleared. In one implementation, the unused state detection circuit 400 will automatically activate a boot up procedure.

According to another aspect of the invention, when the semiconductor circuit 200 is first powered up, the processor 220 can obtain the appropriate program code for the boot up process from the external interface 230. For example, the external interface 230 can be assigned an address in the code space of the processor 220, and the processor 220 can be instructed to launch from the address assigned to the external interface 230. Alternatively, the processor 220 can be instructed to launch from the external interface 230 regardless of an address assignment.

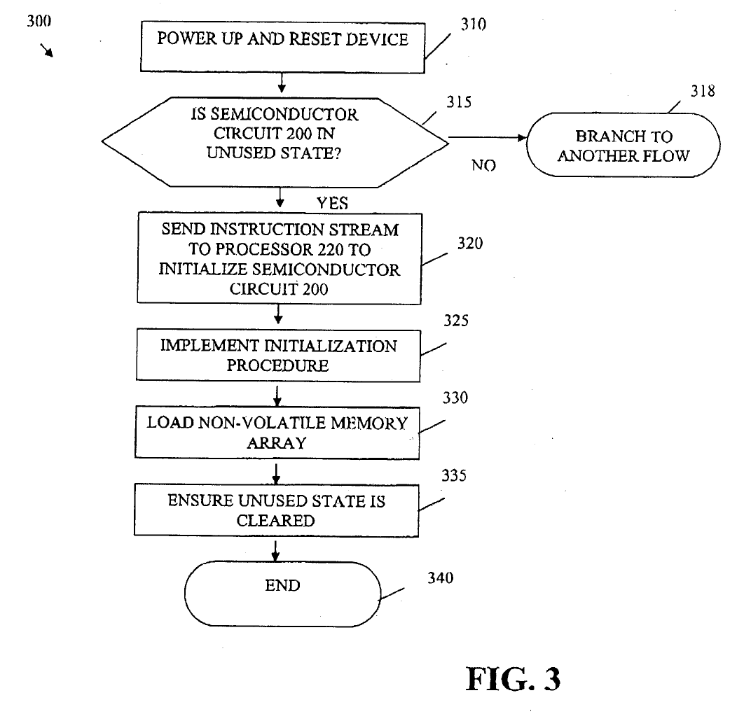

As discussed hereinafter, the external interface 230 can optionally be connected to a testing station 260 or another computing device that provides an instruction stream for execution by the processor 220, such as a stream of bytes having predefined values to indicate appropriate instructions. The testing station 260 communicates with the semiconductor circuit 200 using the external interface 230, in a manner described further below in conjunction with FIG. 3. Generally, the testing station 260 issues a command to the semiconductor circuit 200 through the external interface 230 that is a specific instruction that will be executed by the processor as if it had been read from its code store memory. In this manner, the semiconductor circuit 200 is tested and initialized and the non-volatile memory 240 is loaded with appropriate software. The processor 220 may continue to obtain instructions from the external interface 230 until the initialization process is complete, which may be indicated, for example, by some predefined instruction or pattern issued by the testing station 260 or by other methods, such as removing power from the semiconductor circuit 200.

FIG. 3 is a flow chart describing an exemplary implementation of the first use initialization process 300, implemented by the testing station 260. As shown in FIG. 3, the testing station 260 initially powers up and resets the semiconductor circuit being tested to a known state during step 310. Thereafter, a test is performed during step 315 to determine if the semiconductor circuit 200 is in an unused state. The testing station 260 can determine if the semiconductor circuit 200 is in an unused state, for example, by communicating with the semiconductor circuit 200 on the external interface 230. If a valid response is received from the semiconductor circuit 200, the testing station 260 can assume the semiconductor circuit 200 is in an unused state and is obtaining instructions from the testing station 260 for initialization. In a further variation, the unused state detection circuit 400 can set a flag or another indicator that may be accessed by the testing station 260 and provides an indication that the semiconductor circuit 200 is in an unused state.

If it is determined during step 315 that the semiconductor circuit 200 is not in an unused state, then program control terminates or branches to a different flow during step 318, for example, to perform testing of used semiconductor circuits. If, however, it is determined during step 315 that the semiconductor circuit 200 is in an unused state, then program control proceeds to step 320 for initialization or testing (or both) of the unused semiconductor circuit 200.

The first use initialization process 300 then sends an instruction stream over the external interface 230 during step 320 to the processor 220 to initialize the semiconductor circuit 200. Thereafter, the first use initialization process 300 performs an initialization procedure during step 325 that may include, e.g., testing of the various features and functions of the semiconductor circuit 200. For example, the test procedure can test the SRAM on the semiconductor circuit 200 by writing a pattern to the SRAM memory from zero to 255, and then reads the pattern to confirm the validity of the memory device.

The non-volatile memory is then loaded during step 330 with the appropriate code for further execution (since the previous code may have been overwritten during the pattern testing process). Finally, the testing station 260 ensures that the unused state is permanently cleared, in the manner described herein. Thereafter, program control terminates during step 340.

It is noted that while the exemplary first use initialization process 300 incorporates testing functions performed by an external testing station 260, some or all of the testing of the semiconductor circuit 200 may actually be performed by testing functions embedded on the semiconductor circuit 200, as would be apparent to a person of ordinary skill in the art.

As previously indicated, the unused state detection circuit 400 detects when the semiconductor circuit 200 is first powered up and initialized and thereafter provides an indication that the semiconductor circuit 200 is no longer unused. The unused state detection circuit 400 may use, for example, the state of a non-volatile memory array to detect whether the semiconductor circuit 200 has been previously unused. It is noted, however, that the unused state detection circuit 400 could be implemented in several ways and the particular method employed to detect the unused state is not intended to limit the scope of the present invention.

For a discussion of suitable unused state detection circuits 400, see, for example, U.S. patent application Ser. No. ______, entitled “Method and Apparatus for Detecting an Unused State in a Semiconductor Circuit,” (Attorney Docket Number ATM-626), filed contemporaneously herewith, assigned to the assignee of the present invention and incorporated by reference herein.

It is to be understood that the embodiments and variations shown and described herein are merely illustrative of the principles of this invention and that various modifications may be implemented by those skilled in the art without departing from the scope and spirit of the invention.

We claim:

1. A semiconductor circuit, comprising:
a processor for executing one or more instructions;
a memory device; and
an external interface for receiving a plurality of instructions for said processor to execute upon a first use of said semiconductor circuit.

2. The semiconductor circuit of claim 1, wherein said plurality of instructions are used to initialize said semiconductor circuit.

3. The semiconductor circuit of claim 1, wherein said external interface is a serial interface.

4. The semiconductor circuit of claim 1, wherein said external interface is a parallel interface.

5. The semiconductor circuit of claim 1, wherein said external interface is a Universal Serial Bus.

6. The semiconductor circuit of claim 1, further comprising an unused state detection circuit for detecting said first use.

7. The semiconductor circuit of claim 1, further comprising means for ensuring an unused state is cleared once said semiconductor circuit has been initialized.

8. The semiconductor circuit of claim 1, wherein said plurality of instructions are received from an external computing device.

9. The semiconductor circuit of claim 1, wherein said external interface is mapped to an address space of said processor.

10. The semiconductor circuit of claim 1, wherein said external interface is mapped to the entire address space of said processor

11. The semiconductor circuit of claim 1, wherein said external interface is mapped to a specific address space of said processor after a specific command is sent by said external interface.

12. The semiconductor circuit of claim 1, wherein said processor continues to have the ability to obtain instructions from said external interface until an unused state has been permanently cleared.

13. The semiconductor circuit of claim 1, wherein said processor continues to read said external interface as a memory asset from which code can be fetched.

14. The semiconductor circuit of claim 1, wherein said processor continues to read said external interface as a memory asset from which data can be fetched.

15. A method for use in a semiconductor circuit, comprising:
detecting a first use of said semiconductor circuit; and
receiving a plurality of instructions to execute upon said first use of said semiconductor circuit from an external interface of said semiconductor circuit.

16. The method of claim 13, wherein said external interface is a serial interface.

17. The method of claim 15, wherein said external interface is a parallel interface.

18. The method of claim 15, wherein said external interface is a Universal Serial Bus.

19. The method of claim 15, further comprising the step of ensuring an unused state is cleared once said semiconductor circuit has been initialized.

20. The method of claim 15, wherein said plurality of instructions are received from an external computing device.

21. The method of claim 15, wherein said external interface is mapped to an address space of a processor associated with said semiconductor circuit.

22. The method of claim 15, wherein said instructions are obtained from said external interface until an unused state has been permanently cleared.

23. The method of claim 15, wherein said external interface operates as a memory asset from which code can be fetched.

24. The method of claim 15, wherein said external interface operates as a memory asset from which data can be fetched.
